(19) United States
(12) Patent Application Publication
(10) Pub. No.: US 2003/0054697 A1
(43) Pub. Date: Mar. 20, 2003

(54) Audio connector for a PC card

(76) Inventor: Danut Florescu, Burnaby (CA)

Correspondence Address: Robert E. Krebs, Esquire, Thelen Reid & Priest LLP, P O Box 640640, San Jose, CA, 95164-0640, US

(21) Appl. No.: 09/951,679

(22) Filed: Sep. 14, 2001

(51) Int. Cl. H01R 24/04

(52) U.S. Cl. 439/668

(57) ABSTRACT

An audio connector for a PC card is provided. The audio connector includes a “T” configuration which allows placement of the audio connector within a PCB of the PC card. The audio connector also includes a plurality of contacts and ribs disposed about the audio connector. The contacts provide support for the audio connector during insertion of devices into the audio connector in addition to providing a contact between the audio connector and the PC card. The ribs also provide support to the audio connector during the insertion of devices into the audio connector. In addition to providing support, the ribs allow self-aligning capability to the audio connector within the PCB during insertion of the audio connector into the PCB.

### BACKGROUND OF THE INVENTION

1. Field of the Invention

The present invention relates generally to audio connectors. More specifically, the present invention relates to miniature audio connectors for use with PC cards.

2. Description of Related Art

Today, users reliance on wireless communication continues to steadily increase. This reliance includes the use of wireless communication with mobile devices such as laptop computers and personal data assistants (PDA). These mobile devices have the ability to send and receive data, such as files, facsimiles or the like, using wireless PC cards, such as wireless modems.

The PC cards allowing wireless communication include various components such as an audio connector which aid a user of the laptop computer. The audio connector increases the functionality of the PC card, this functionality includes providing an audio input for a laptop computer. In addition, if a user interfaces the PC card with a PDA, the PDA may function as a cellular telephone. A user engages the audio connector by inserting an implement, such as a plug for a cellular telephone, into the audio connector. Nonetheless, prior art audio connectors posed reliability problems for PC cards implementing the prior art audio connectors. As the user inserted a plug into a prior art audio connector, the user imparted various forces on the audio connector which weakened prior art audio connectors within the PC card. To further illustrate, prior art audio connectors resided on an extended portion of the PC card above a PCB of the PC card. Prior art audio connectors were soldered with the PCB via soldering contacts on the audio connector. As such, the soldering contacts provided the only means for securing prior art audio connectors with the PCB. Over time, connection of the audio connector with the PCB degrades, eventually causing failure when the audio connector disengages with the PCB from repeated usage due to insertion and disengagement of implements with the audio connector. As such, overall reliability of a PC card using prior art audio connectors suffered.

Furthermore, prior art audio connectors typically engaged with extended Type II PC cards such as a Nokia C110/C111 Wireless LAN Card available from Nokia Incorporated located in Irving, Texas. Extended Type II PC cards generally are nonstandard cards which are bigger in size and much bulkier. Due to the larger size and the attendant bulkiness, extended Type II PC cards protrude from mobile devices, such as the aforementioned laptop computers. As such, users must remove the PC card from the laptop during travel in order to minimize the possibility of damaging the PC card.

Moreover, prior art audio connectors resided on the extended portion of the PC card above the PCB within the PC card. Prior art audio connectors required a great amount of clearance relative to the overall dimensions of PC card due to having the audio connector reside above the PCB. Therefore, the only option for interfacing an audio connector with a PC card involved using an extended PC card in order to provide greater clearance within the PC card. As such, applications involving non-extended PC cards could not use audio connectors.

Therefore a need exists for an audio connector which may be soldered to a PCB of a PC card. Moreover, the configuration of the audio connector should allow for placement within a Type II unextended PC card upon soldering of the audio connector with the PC card.

### BRIEF SUMMARY OF THE INVENTION

The present invention fills the aforementioned needs by providing an audio connector configured for central location within a PCB. The audio connector provides audio capability for a PC card using the PCB.

In one embodiment of the present invention, an audio connector for providing audio connectivity for a PC card is disclosed. The configuration of the audio connector allows for placement of the audio connector within a PCB of the PC card. The audio connector situates within the PCB such that the PCB is adjacent an intermediate portion of the audio connector. In addition, a top surface of the audio connector is adjacent a top surface of the PC card and a bottom surface of the audio connector is adjacent a bottom surface of the PC card.

In another embodiment of the present invention, an audio connector for a PC card is disclosed. The audio connector includes a “T” configuration which allows for placement of the audio connector within a PCB of the PC card. During placement of the audio connector within the PCB, the PCB bisects the “T” configuration such that an upper portion of the “T” configuration is adjacent a top surface of the PC card. Additionally, the PCB bisects the “T” configuration such that a lower portion of the “T” configuration is adjacent a bottom surface of the PC card.

In a further embodiment of the present invention, an audio connector for providing audio capabilities for a PC card is disclosed. The audio connector includes a “T” configuration having a top portion and a lower portion. The “T” configuration allows the audio connector to reside within a PCB of the PC card when the audio connector is disposed within the PC card. The audio connector also includes guides around a periphery of the audio connector for providing self-aligning capabilities during insertion within the PCB. In addition, when the audio connector resides within the PC card the upper portion is adjacent a top surface of the PC card and the lower portion of the PC card is adjacent a bottom surface of the PC card.

As may be appreciated, the present invention discloses an audio connector which resides within a PCB of a PC card. The configuration of the audio connector allows for use in a non-extended, Type II PC card.

### BRIEF DESCRIPTION OF THE SEVERAL VIEWS OF THE DRAWING(S)

Many advantages of the present invention will be apparent to those skilled in the art with a reading of this specification in conjunction with the attached drawings, wherein like reference numerals are applied to like elements and wherein:

FIG. 1 shows a perspective view of a PC card having an audio connector in accordance with one embodiment of the present invention.

FIG. 2A is an embodiment of the present invention illustrating a perspective view of the audio connector shown with respect to FIG. 1.

FIG. 2B shows a schematic backside view of the audio connector shown with reference to FIG. 2A, in accordance with one embodiment of the present invention.

FIG. 3 is an embodiment of the present invention illustrating a schematic of the audio connector shown with reference to FIG. 2A residing within a PCB of a PC card.

FIG. 4 is an embodiment of the present invention illustrating the audio connector shown with reference to FIG. 2A within a PCB of a PC card.

### DETAILED DESCRIPTION OF THE INVENTION

The present invention discloses an audio connector. An audio connector in accordance with the present invention allows for soldering within a PCB of a PC card. The PC card may be any type of PC card capable of providing wireless communication, such as a Type II PCMCIA PC card. As will be discussed in greater detail with reference to the accompanying Figures. The configuration of the audio connector allows for soldering of the audio connector with a PCB of an unextended PC card.

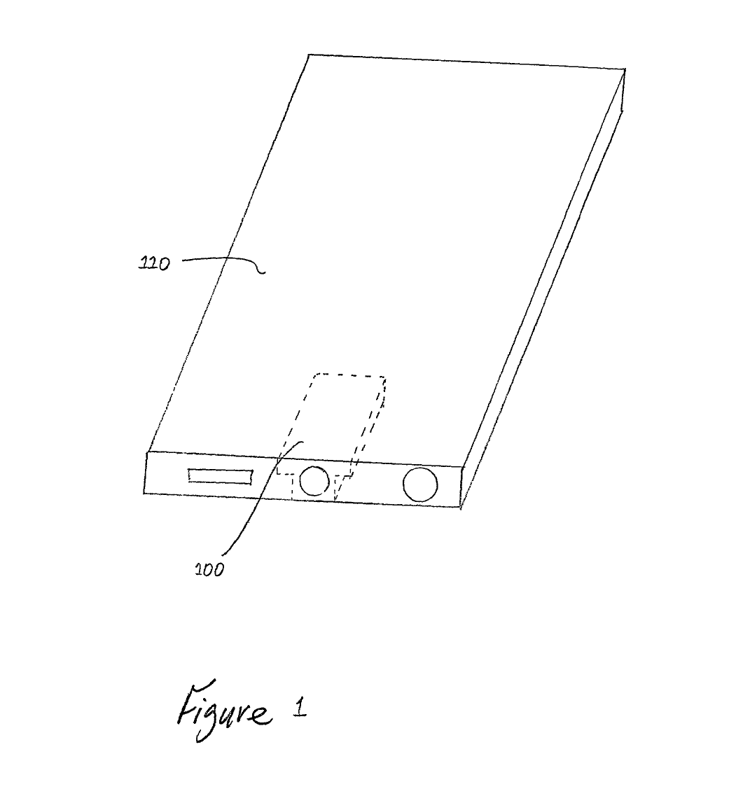

Now making reference to the Figures, and more particularly to FIG. 1, FIG. 1 shows a schematic of a PC card 110 having an audio connector 100 in accordance with one embodiment of the present invention. In this embodiment, the PC card 110 may be any Type II unextended PC card, such as an AirCard™ 300 available from Sierra Wireless, Incorporated, located in Richmond, British Columbia Canada, or the like. [Note to Dan: Please fill in the blank with an example of a Type II PC card. Thanks] The audio connector 100 provides audio capabilities for a computing device (not shown), such as a laptop computer or a personal data assistant (PDA), using the PC card 110. An example of the functionality provided by the audio connector 100 includes providing an audio input for the computing device thereby allowing a user to use of the audio connector 100 as an audio input/output for the computing device. Additionally, if the PC card attaches to a PDA, the PDA may function may as a cellular telephone upon the insertion of headphones within the audio connector 100. Likewise, the audio connector 100 allows a user to listen to transmissions from the PC card 110 during data transmission by the PC card 110 upon placement of a listening device (i.e., microphone) within the audio connector 100.

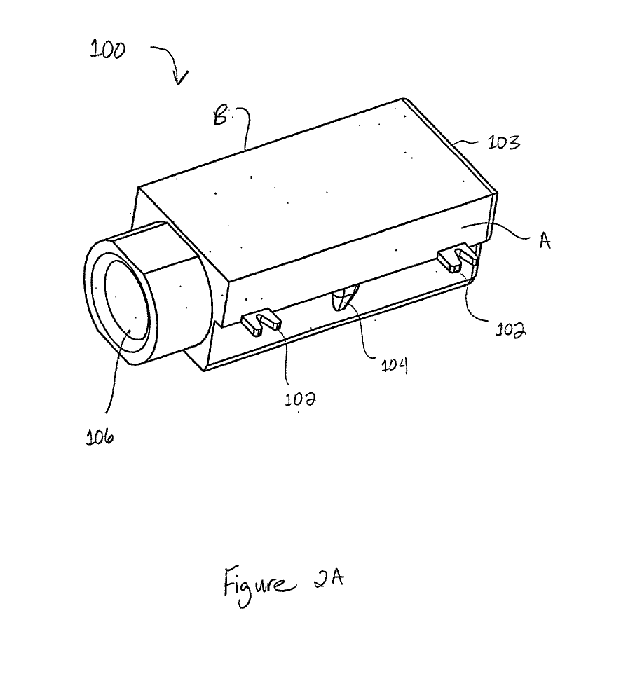

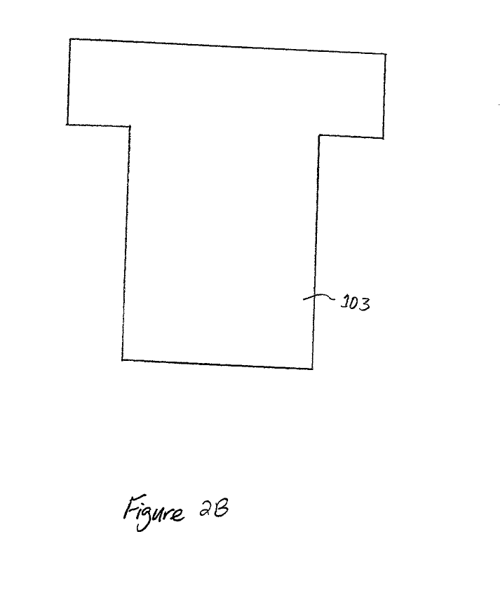

The PC card 110 also includes the audio connector 100, as shown with reference to FIG. 2A. FIG. 2A is a perspective view of the audio connector 100 shown with respect to FIG. 1 in accordance with one embodiment of the present invention. As may be seen with reference to the Figure, the audio connector includes contacts 102, an endcap 103, ribs 104 and a plug 106. The contacts 102 provide contact points for the audio connector 100 and a PCB 108. The contacts 102 also absorb forces imparted upon the audio connector 100 during insertion of devices (i.e., headphones) into the plug 106. In addition to the two contacts 102 shown on side A of the audio connector 100, the audio connector 100 includes two additional contacts 102 (not shown) on a side B opposite the side A. The plurality of the contacts 102 provide additional soldering points to the audio connector 100, thereby increasing the overall strength of the audio connector 100. In addition, the plurality of the contacts 102 increase the ability of the audio connector 100 to resist the previously described forces imparted to the audio connector 100 during insertion of devices into the audio connector 100.

In addition to the contacts 102, the audio connector 100 also includes the endcap 103. The endcap 103 encloses a backside of the audio connector 100 on an end opposite the plug 106. As may be seen with reference to FIG. 2B, the endcap 103 encloses a backside of the audio connector 100. The configuration of the endcap 103 at the backside of the audio connector 100 minimizes moisture seepage into the audio connector 100, thereby increasing the reliability of the audio connector 100 and the overall reliability of the PC card 110 and any other device using the audio connector 100.

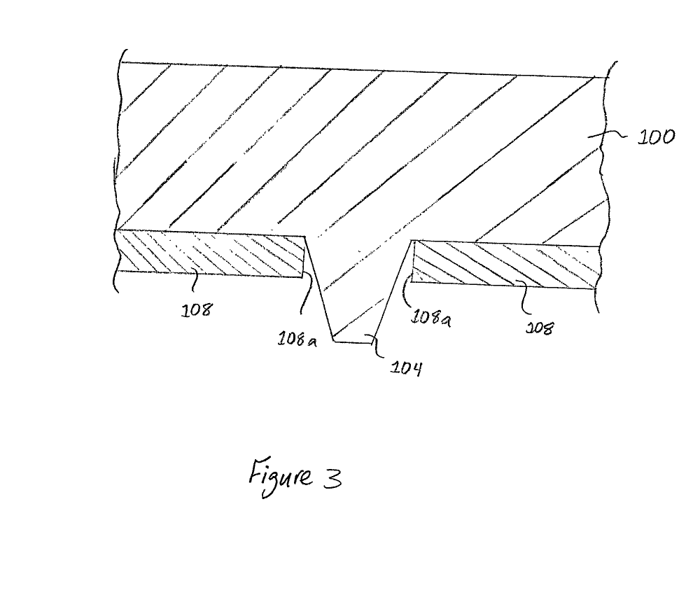

Returning attention to FIG. 2A, the audio connector 100 also includes the ribs 104. As shown with reference to FIG. 3, the rib 104 sits within a gap 108a of the PCB 108. Thus, the ribs 104 function as guides and provide precise self-aligning capability for the audio connector 100 during insertion of the audio connector 100 into the PCB 108. As may be appreciated, the self-aligning characteristic of the audio connector 100 decreases the time and cost associated with manufacturing a PC card such as the PC card 110 utilizing the audio connector 100. In addition, the ribs 104 lock the audio connector 100 into place with the PCB 108, thereby minimizing the possibility of dislodgement of the audio connector 100 with the PCB 108 during use of the PC card 110. Moreover, as described with reference to the contacts 102, the ribs 104 absorb forces imparted on the audio connector 100 during insertion of devices into the audio connector 100. As such, the increased force resistance by the ribs 104 increases overall reliability of the PC card 110 and other devices using the audio connector 100.

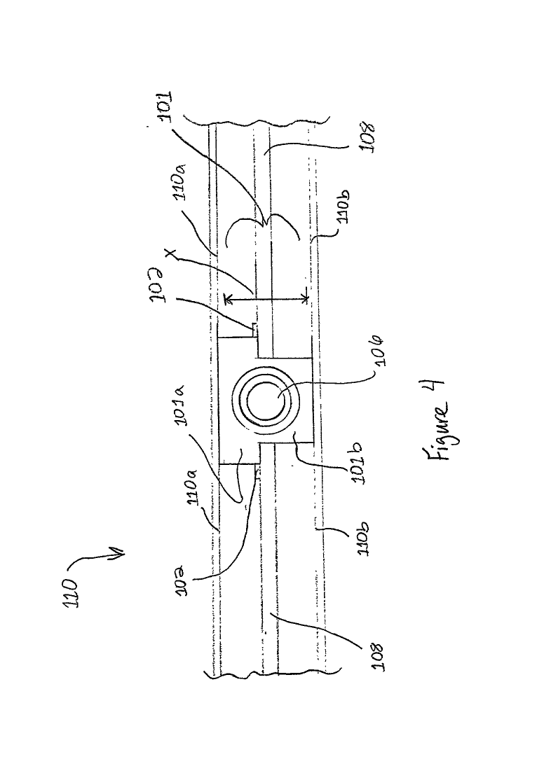

Turning back to FIG. 2A, the audio connector 100 also includes the plug 106. The plug 106 provides connectivity between the audio connector 100 and other devices which connect with the audio connector 100. The plug 106 may be any plug suitable for facilitating connection between the audio connector 100 and devices which use the audio connector 100, such as the aforementioned headphones. An example of a plug which may be includes a 2.5 mm plug. As described earlier, the configuration of the audio connector 100 allows for placement within the PCB 108, as shown with reference to FIG. 4.

Now making reference to FIG. 4, FIG. 4 is an embodiment of the present invention illustrating the audio connector 100 shown with reference to FIG. 2A within the PCB 108. The audio connector 100 has a “T” configuration 101 which allows for placement of the audio connector 100 within the PCB 108. The “T” configuration 101 of the audio connector 100 includes an upper portion 101a and a lower portion 101b. The PCB 108 bisects the “T” configuration 101 formed by the upper portion 101a and the lower portion 101b. The PCB 108 bisects the “T” configuration 101 such that the upper portion 101b is adjacent a top surface 110a of the PC card 110. Likewise, the PCB 108 bisects the “T” configuration 101 such that the lower portion 101b is adjacent a bottom surface 110b of the PC card 110. In one embodiment of the present invention, the audio connector 100 preferably has an overall thickness X of about 4.0 mm. As may be seen with reference to the Figure, the audio connector 100 resides within the PCB 108, instead of above the PCB 108.

As may be appreciated, the present invention now provides an audio connector for use in a Type II unextended PC card. The configuration of the audio connector of the present invention allows for placement within a PCB of a PC card via soldering. Thus, the audio connector may fit within the tight spaces of a PC card, thereby providing an unextended Type II PC card having an audio connector. As such, devices using the present invention may avoid use of extended Type II PC cards and the attendant disadvantages associated with extended Type II PC cards (e.g., larger size, bulkiness, etc.).

Furthermore, the audio connector of the present invention improves overall reliability of PC cards using the audio connector. As described earlier, the additional contacts and ribs of the audio connector improve the resistance of the audio connector to forces imparted during insertion of devices into the plug of the audio connector. Therefore, overall reliability increases since the increased resistance makes the audio connector less prone to deterioration due to these forces. Moreover, the self-aligning capabilities provided by the previously described ribs reduce the possibility of the audio connector losing alignment during a reflow process of the PC card. As such, the self-aligning capability minimizes rework time necessary to realign the audio connector after the reflow process.

The above are exemplary modes of carrying out the invention and are not intended to be limiting. It will be apparent to those of ordinary skill in the art that modifications thereto can be made without departure from the spirit and scope of the invention as set forth in the accompanying claims.

1. An audio connector for providing audio connectivity for a PC card, the audio connector being configured for placement within a PCB of the PC card such that the configuration of the audio configuration allows the PCB to be adjacent an intermediate portion of the audio connector, wherein the configuration of the audio connector is such that a top surface of the audio connector is adjacent a top surface of the PC card and a bottom surface of the audio connector is adjacent a bottom surface of the PC card when the audio connector is within the PCB.

2. An audio connector as recited in claim 1, wherein the audio connector has a “T” configuration, the “T” configuration allowing placement of the audio connector within the PCB of the PC card.

3. An audio connector as recited in claim 1, wherein the audio connector has a height of no more than 4 mm.

4. An audio connector as recited in claim 1, the audio connector further comprising:
ribs disposed about a periphery of the audio connector.

5. An audio connector as recited in claim 4, wherein the ribs provide self-aligning capability for the audio connector within the PCB.

6. An audio connector as recited in claim 1, the audio connector further comprising:
an endcap disposed on the audio connector to provide sealing capabilities.

7. An audio connector as recited in claim 6, wherein the audio connector is moisture resistant.

8. An audio connector as recited in claim 1, wherein the audio connector includes a dummy contact for providing support.

9. An audio connector as recited in claim 1, wherein the PC card is a Type II unextended PC card.

10. An audio connector, the audio connector being disposed within a PC card, the audio connector having a “T” configuration such that a PCB of the PC card bisects the “T” configuration when the audio connector resides within the PCB of the PC card, the “T” configuration having an upper portion and a lower portion where the top portion is adjacent a top surface of the PC card and the lower portion is adjacent a bottom surface of the PC card.

11. An audio connector as recited in claim 10, the audio connector further comprising:
ribs disposed about the audio connector.

12. An audio connector as recited in claim 11, wherein the ribs provide self-aligning capability for the audio connector within the PCB.

13. An audio connector as recited in claim 10, the audio connector further comprising:
an endcap disposed on the audio connector.

14. An audio connector as recited in claim 10, the audio connector further comprising:
a dummy contact for providing additional support to the audio connector.

15. An audio connector as recited in claim 10, wherein the PC card is a Type II unextended PC card.

16. An audio connector for providing audio capabilities for a PC card, the audio connector having a “T” configuration where the “T” configuration includes an upper portion and a lower portion such that the audio connector disposes within a PCB of the PC card, wherein the audio connector includes guides disposed about a periphery of the audio connector for providing self-aligning capabilities within the PCB, the upper portion of the “T” configuration being adjacent a top surface of the PC card and the lower portion of the “T” configuration being adjacent a bottom surface of the PC card when the audio connector is disposed within the PC card.

17. An audio connector as recited in claim 15, the audio connector further comprising:
ribs disposed about the audio connector.

18. An audio connector as recited in claim 16, wherein the ribs provide self-aligning capability for the audio connector within the PCB.

19. An audio connector as recited in claim 15, the audio connector further comprising:
a dummy contact for providing additional support to the audio connector.

20. An audio connector as recited in claim 15, wherein the PC card is a Type II unextended PC card.
